(19) United States
(12) Patent Application Publication
(10) Pub. No.: US 2018/0164952 A1
(43) Pub. Date: Jun. 14, 2018

(54) VIRTUAL INTERFACE DISPLAY METHOD, ELECTRONIC DEVICE, AND APPARATUS

(71) Applicant: Lenovo (Beijing) Co., Ltd., Beijing (CN)

(72) Inventor: Cen YAO, Beijing (CN)

(21) Appl. No.: 15/839,114

(22) Filed: Dec. 12, 2017

(30) Foreign Application Priority Data
Dec. 12, 2016 (CN) 201611139100.8
Dec. 12, 2016 (CN) 201611139110.1

(51) Int. Cl. G06F 3/0481; G06F 3/01; G06F 3/0488

(52) U.S. Cl. CPC G06F 3/0481; G06F 3/012; G06F 2203/04804; G06F 3/04883; G06F 2203/04803; G06F 3/04886

(57) ABSTRACT

A virtual interface display method and an electronic device for an electronic device are provided. The method comprises: based on location information of a user's head, determining a spherical reference plane; determining a plane tangential to a reference point on the spherical reference plane as a target tangent plane; configuring a target virtual interface based on the target tangent plane; and displaying the target virtual interface to the user. When the location information of the user's head is a central point of the user's head, the central point of the user's head is used as a center of the spherical reference plane, and a distance from the central point of the user's head to an existing display interface is used as a radius of the spherical reference plane, thereby determining the spherical reference plane.

### CROSS-REFERENCES TO RELATED APPLICATIONS

This application claims priority of Chinese Patent Application No. 201611139110.1, filed on Dec. 12, 2016, and Chinese Patent Application No. 201611139100.8, filed on Dec. 12, 2016, the entire contents of all of which are hereby incorporated by reference.

### FIELD OF THE INVENTION

The present disclosure generally relates to the technical field of information display and, more particularly, relates to a virtual interface display method, electronic device, and apparatus.

### BACKGROUND

Currently, by using virtual display devices such as augmented reality (AR) glasses, display of virtual interfaces or windows in the space may be realized. However, locations of the virtual interfaces to be displayed in the space and the way of displaying the virtual interfaces in the space that allows the user to relatively comfortably watch the virtual interfaces displayed in the space are issues to be solved.

### BRIEF SUMMARY OF THE DISCLOSURE

One aspect of the present disclosure provides a virtual interface display method for an electronic device. The method comprises: based on location information of a user's head, determining a spherical reference plane; determining a plane tangential to a reference point on the spherical reference plane as a target tangent plane; configuring a target virtual interface based on the target tangent plane; and displaying the target virtual interface to the user. When the location information of the user's head is a central point of the user's head, the central point of the user's head is used as a center of the spherical reference plane, and a distance from the central point of the user's head to an existing display interface is used as a radius of the spherical reference plane, thereby determining the spherical reference plane. When the location information of the user's head is a midpoint of a line connecting two eyes of the user, the midpoint is used as the center of the spherical reference plane, and a distance from the midpoint to the existing display interface is used as the radius of the spherical reference plane, thereby determining the spherical reference plane.

Another aspect of the present disclosure provides an electronic device. The electronic device includes a sensor and a processor. The sensor detects location information of a user's head. The processor determines a spherical reference plane based on the location information of the user's head collected by the sensor, determines a plane tangential to a reference point on the spherical reference plane as a target tangent plane, and configures a target virtual interface in the target tangent plane.

Another aspect of the present disclosure provides a virtual display method. The virtual display method comprises: based on location information of a user, determining a virtual main display region; dividing the main display region into a plurality of sub-display regions; and detecting a triggering operation of the user, and performing display of a target window in at least one sub-display region among the plurality of sub-display regions.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in disclosed embodiments of the present invention, drawings necessary for the description of the disclosed embodiments are briefly introduced hereinafter. Obviously, the drawings described below are only some embodiments of the present invention, and it is possible for those ordinarily skilled in the art to derive other drawings from these drawings without creative effort.

FIG. 1 illustrates a flow chart of a virtual interface display method according to embodiments of the present disclosure;

FIG. 2 illustrates another flow chart of a virtual interface display method according to embodiments of the present disclosure;

FIG. 3 illustrates a schematic view showing determination of a spherical reference plane based on location information of a user's head according to embodiments of the present disclosure;

FIG. 4 illustrates another schematic view showing determination of a spherical reference plane based on location information of a user's head according to embodiments of the present disclosure;

FIG. 5 illustrates a structural schematic view of an electronic device according to embodiments of the present disclosure;

FIG. 6 illustrates a structural schematic view of a display device of a virtual interface according to embodiments of the present disclosure;

FIG. 7 illustrates a flow chart of another virtual interface display method according to embodiments of the present disclosure;

FIG. 8 illustrates a schematic view of a main display region according to embodiments of the present disclosure;

FIG. 9 illustrates a schematic view of a plurality of sub-display regions divided based on a dimension of a display screen of an electronic device according to embodiments of the present disclosure;

FIG. 10(a)-FIG. 10(d) illustrate schematic views showing the display of a target window in a sub-display region based on a triggering operation of a user according to embodiments of the present disclosure;

FIG. 11 illustrates a schematic view showing the display of a plurality of windows within a main display region in a plurality of sub-display regions within the main display region according to embodiments of the present disclosure;

FIG. 12 illustrates a structural schematic view of another electronic device according to embodiments of the present disclosure; and

FIG. 13 illustrates a structural schematic view of a display device according to embodiments of the present disclosure.

### DETAILED DESCRIPTION

Hereinafter, technical solutions in embodiments of the present disclosure will be described clearly and more fully with reference to the accompanying drawings. Obviously, embodiments described herein are only a part of embodiments of the present disclosure, but not all embodiments. Based on embodiments of the present disclosure, other embodiments obtainable by those ordinarily skilled in the relevant art without creative labor shall all fall within the protection scope of the present disclosure.

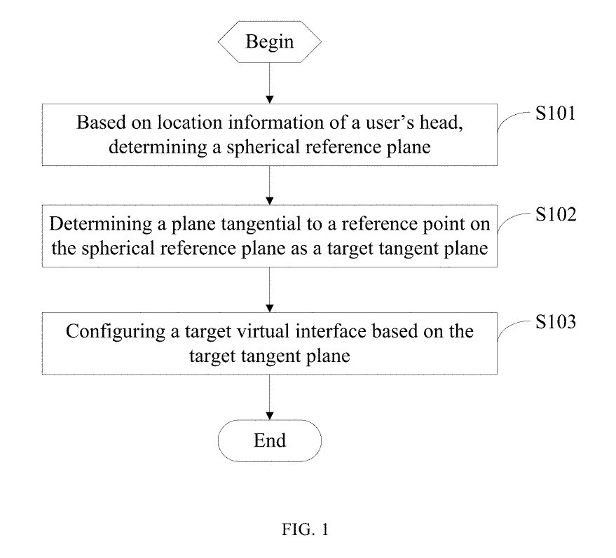

The present disclosure provides a virtual interface display method, and the method may be applied to an electronic device. FIG. 1 illustrates a flow chart of a virtual interface display method according to embodiments of the present disclosure. As shown in FIG. 1, the virtual interface display method may include the following steps (Step S101˜Step S103).

Step S101: based on location information of a user's head, determining a spherical reference plane.

Step S102: determining a plane tangential to a reference point on the spherical reference plane as a target tangent plane. For example, the target tangent plane may be a virtual display screen in the space, and the virtual display screen may be configured to display a target virtual interface. Optionally, a plurality of planes each tangential to a corresponding reference point on the spherical reference plane are determined as target tangent planes. That is, the number of target tangent planes may be one or more.

Step S103: configuring a target virtual interface based on the target tangent plane. Optionally, when a plurality of target tangent planes exist, a plurality of target virtual interfaces may be configured based on the plurality of target tangent planes. More specifically, the plurality of target virtual interfaces and the plurality of target tangent planes may be in one-to-one correspondence.

Optionally, the virtual interface display method may further include Step S104. In Step S104, the target virtual interface may be displayed to the user.

In the disclosed virtual interface display method, a spherical reference plane is first determined based on the location information of the user's head, a plane that is tangential to a reference point on the spherical reference plane is then determined as a target tangent plane, and a target virtual interface is eventually configured based on the target tangent plane. The virtual interface display method provided by embodiments of the present disclosure allows distances from virtual interfaces displayed in different orientations to the user to be all desired display distances. Further, the virtual interfaces may be all displayed in planes, thereby satisfying focusing and reading habits of human eyes. That is, the user may relatively comfortably watch the virtual interfaces displayed in the space, and the user experience may be relatively good.

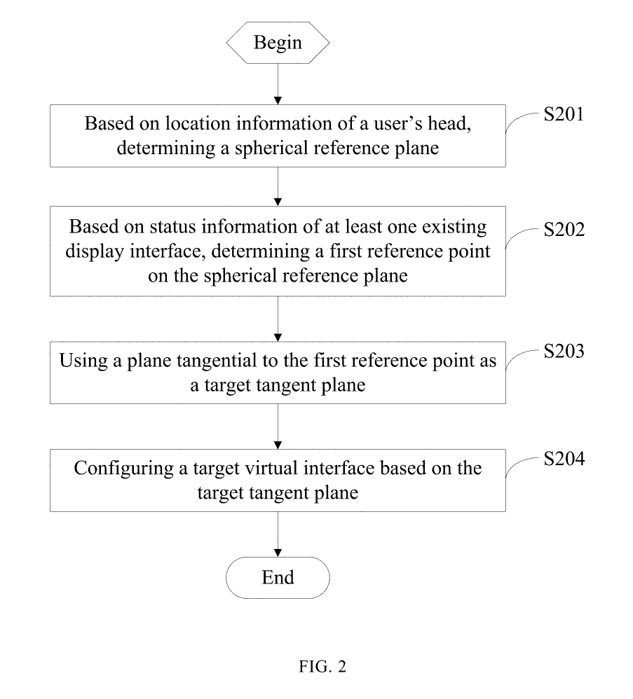

FIG. 2 illustrates another flow chart of a virtual interface display method according to embodiments of the present disclosure. The disclosed method may be applied to an electronic device, and may comprise the following steps (Step S201˜Step S204).

Step S201: based on location information of a user's head, determining a spherical reference plane. For example, the location information of the user's head may be collected using an AR head-wearing device or a camera included in an electronic device.

If the spherical reference plane is to be determined, the center and the radius of the spherical reference plane may need to be determined. More specifically, a determination method of the spherical reference plane may be as follows.

In one embodiment, the location information of the user's head may be a central point of the user's head. That is, the central point of the user's head may be used as a center of sphere to determine the spherical reference plane. In another embodiment, the location information of the user's head may be a midpoint of a line connecting two eyes of the user's head. That is, the midpoint of the line connecting two eyes of the user's head may be used as the center of sphere to determine the spherical reference plane.

After determining the center of sphere of the spherical reference plane, the radius of the spherical reference plane may need to be further determined. A determination process of the radius of the spherical reference plane may include: based on the location information of the user's head, determining a distance between the user's head and an existing display interface; based on the distance between the user's head and the existing display interface, obtaining a radius of the spherical reference plane; and based on the radius of the spherical reference plane, determining the spherical reference plane.

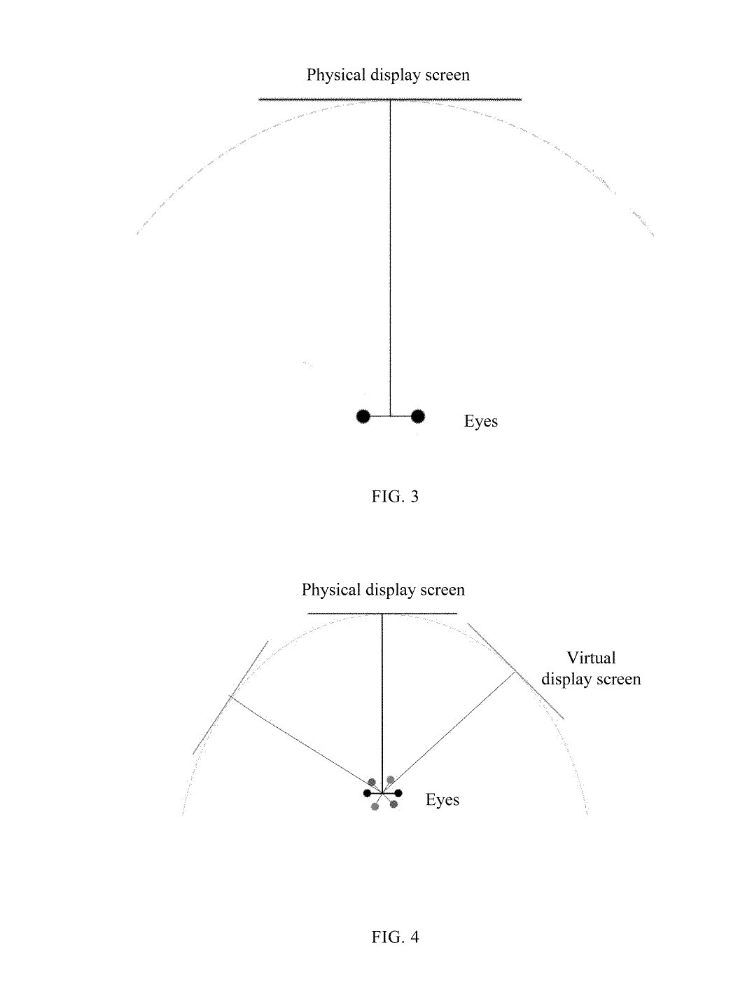

In particular, the existing display interface may be a physical display screen, or may be a virtual display interface. FIG. 3 illustrates a schematic view of determining a spherical reference plane based on location information of a user's head according to embodiments of the present disclosure. FIG. 4 illustrates another schematic view of determining a spherical reference plane based on location information of a user's head according to embodiments of the present disclosure.

As shown in FIG. 3, the spherical reference plane is determined using the midpoint of the line connecting the two eyes of the user's head as the center of sphere and using a distance from the midpoint of the line connecting the two eyes of the user's head to the physical display screen (i.e., the actual display screen) as the radius. Further, as shown in FIG. 4, the spherical reference plane may be determined using the midpoint of the line connecting the two eyes of the user's head as the center of sphere and using a distance from the midpoint of the line connecting the two eyes in the user's head to the virtual display screen as the radius.

Step S202: based on status information of at least one existing display interface, determining a first reference point on the spherical reference plane. More specifically, the status information of the existing display interface may include the location of the existing display interface and the dimension of the existing display interface.

For example, if the existing display interface is a physical display screen illustrated in FIG. 4, the first reference point may be determined based on the location of the physical display screen, the dimension of the physical display screen, and the dimension of a target virtual interface. The determined first reference point may allow a distance between adjacent borders of the physical display screen and the target virtual interface to be within a preset range.

As shown in FIG. 4, a certain distance is maintained between a right border of the physical display screen and a left border of the virtual display interface disposed on the right side of the physical display screen. Accordingly, not only display of the physical display screen and the target virtual interface do not affect each other, but the distance between the physical display screen and the target virtual interface may not be too long, such that the user may relatively conveniently watch the physical display screen and the target virtual interface.

Further, the present disclosure may determine and configure a plane of the virtual interface along any direction based on an existing display interface. For example, reference points may be determined in the upper side, lower side, left side, and right side of the existing display interface based on the aforementioned method. Further, the virtual interface may be configured in the plane that is tangential to a reference point, thereby realizing the display of virtual interfaces in the upper side, lower side, left side, and right side of the existing display interface. That is, the display of a plurality of virtual interfaces may be implemented.

It should be understood that, when a plurality of virtual interfaces are displayed, the planes configured to display the plurality of virtual interfaces may be planes tangential to the reference points on the spherical reference plane, and the user may be in the position of the center of the sphere. Accordingly, no matter what specific location a virtual display is displayed, the distance between the virtual interface and the user may be the desired display distance.

Step S203: using a plane tangential to the first reference point as a target tangent plane.

Step S204, configuring a target virtual interface based on the target tangent plane.

In one embodiment, to enable the user to watch the target virtual interface conveniently, the reference point where the target tangent plane is tangential to the spherical reference plane is used as a center, and a virtual interface is configured in the target tangent plane. For example, the virtual interface may be displayed in a region where the reference point of the target tangent plane is located.

In the disclosed virtual interface display method, a spherical reference plane is first determined based on the location information of the user's head, and a first reference point is then determined on the spherical reference plane based on the status information of at least one existing display interface. Further, the plane tangential to the first reference point is used as the target tangent plane, and the target virtual interface is configured based on the target tangent plane. The virtual interface display method provided by embodiments of the present disclosure allows all the distances from virtual interfaces displayed in different orientations to the user to be desired display distances. Further, the virtual interfaces may all be displayed in planes, thereby satisfying focusing and reading habits of human eyes. That is, the user may relatively comfortably watch the virtual interfaces displayed in the space, and the user experience may be relatively good.

Based on the virtual interface display method provided by the aforementioned embodiments of the present disclosure, a specific example is provided hereinafter for illustrative purposes.

A user may wear a pair of AR glasses, and the pair of AR glasses may be connected to a PC. Optionally, the pair of AR glasses may be utilized to collect location information of the head of the user that wears the AR glasses and then send the location information of the user's head to the PC. Or, optionally, the PC may directly utilize its own camera to collect the location information of the user's head.

The location information of the user's head may be the midpoint of a line connecting the two eyes of the user or a central point of the user's head. Using the midpoint of the line connecting the two eyes of the user or the central point of the user's head as the center of the sphere, the distance between the user's head and the PC display screen is then determined. Further, using the distance between the user's head and the PC display screen as the radius, a spherical reference plane is determined, where the user may correspond to the center of the sphere of the spherical reference plane.

Further, when the user triggers the target virtual interface corresponding to the PC display screen to be displayed in the space, the user may determine the first reference point on the spherical reference plane based on the location of the PC display screen, the dimension of the PC display screen, and the dimension of the target virtual interface. The determined first reference point may allow the distance between adjacent borders of the PC display screen and the target virtual interface within a preset distance. Further, using the first reference point as a center, the target virtual interface is displayed in the plane tangential to the first reference point.

Via the aforementioned process, the virtual interface may be displayed in any orientation of the PC display screen. For example, a first virtual interface may be displayed on the upper side of the PC display screen, the second virtual interface may be displayed on the left side of the PC display screen, and the third virtual interface may be displayed on the right side of the PC display screen.

Obviously, the present disclosure may perform extension based on a certain displayed virtual interface. For example, using the third virtual interface as a reference, a fourth virtual interface may be displayed on the right side of the third display interface, such that a plurality of virtual interfaces may be displayed on a plurality of planes in the space. Because each virtual interface is displayed in a plane tangential to the spherical reference plane and the user is located in the center of the sphere, the distance from the user to each virtual interface is a desired watching distance. Further, the AR glasses worn by the user may process and display the content of the plurality of display interfaces displayed in the space to the user.

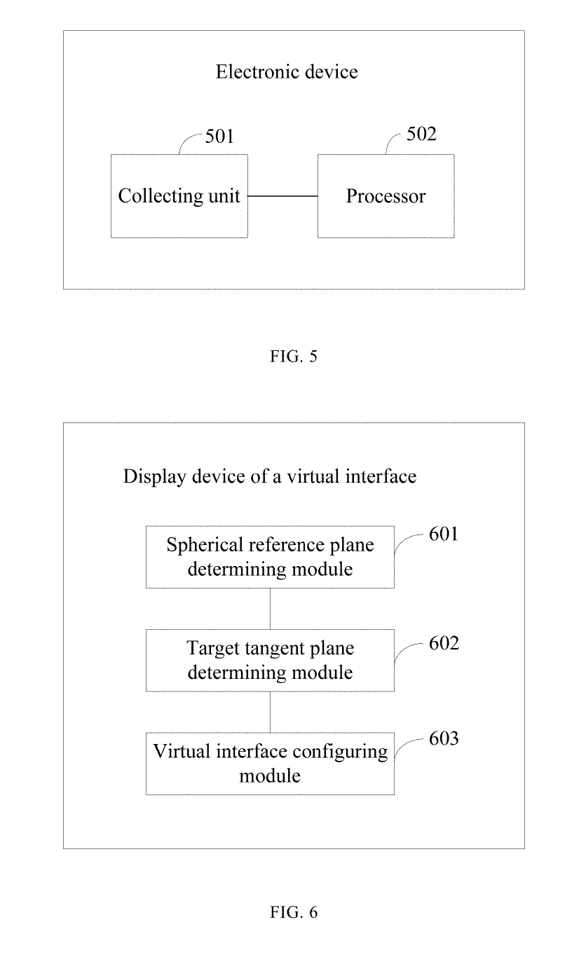

Embodiments of the present disclosure further provide an electronic device. FIG. 5 illustrates a structural schematic view of an electronic device according to embodiments of the present disclosure. As shown in FIG. 5, the electronic device may include a collecting unit 501, and a processor 502.

More specifically, the collecting unit 501 may be configured to collect location information of a user's head. The processor 502 may be configured to, based on the location information of the user's head collected by the collecting unit 501, determine a spherical reference plane. The processor 502 may further determine a plane tangential to a reference point on the spherical reference plane as a target tangent plane, and configure a target virtual interface based on the target tangent plane.

Optionally, the collecting unit 501 may be a sensor, a single camera, or multiple cameras, or any device for capturing location information of a physical object. Optionally, the processor 502 may be one or more hardware devices, such as a central processing unit (CPU), a graphics processing unit (GPU), a digital signal processor (DSP), etc., that are able to execute computer-readable instructions stored in a memory.

In the electronic device provided by embodiments of the present disclosure, the processor may determine a spherical reference plane based on the location information of the user's head that is collected by the collecting unit, and then determine a plane that is tangential to the reference point on the spherical reference plane as a target tangent plane. Further, the processor may configure the target virtual interface based on the target tangent plane. The disclosed electronic device may allow all distances between the virtual interfaces displayed in different orientations and the user to be desired display distances. Further, the virtual interfaces may be each displayed in a plane, thereby satisfying focusing and reading habits of human eyes. That is, the user may relatively comfortably watch the virtual interfaces displayed in the space, and the user experience may be relatively good.

In the electronic device provided by the aforementioned embodiments, the processor is specifically configured to use the central point of the user's head or the midpoint of the line connecting the two eyes in the user's head as a center of the sphere, and determine the spherical reference plane based on the center of the sphere.

In the electronic device provided by the aforementioned embodiments, the processor is specifically configured to determine a distance between the user's head and the existing display interface based on the location information of the user's head, obtain the radius of a spherical reference plane based on the distance, and determine the spherical reference plane based on the radius.

In the disclosed electronic device, the processor is specifically configured to, based on status information of at least one existing display interface, determine a first reference point on the spherical reference plane, and use a plane tangential to the first reference point as the target tangent plane.

In the disclosed electronic device, the processor is specifically configured to, based on the location and dimension of at least one existing display interfaces adjacent to a to-be-displayed location of the target virtual interface, as well as the dimension of the target virtual interface, determine the first reference point on the spherical reference plane.

In the disclosed electronic device, the existing display interface may be a physical display screen or a virtual display interface.

In the disclosed electronic device, the processor is specifically configured to, using the reference point where the target tangent plane is tangential to the spherical reference plane as a center, configure a virtual interface in the target tangent plane.

The present disclosure further provides a display device of a virtual interface. FIG. 6 illustrates a structural schematic view of a display device of a virtual interface according to embodiments of the present disclosure. As shown in FIG. 6, the display device of the virtual interface may include a spherical reference plane determining module 601, a target tangent plane determining module 602, and a virtual interface configuring module 603.

More specifically, the spherical reference plane determining module 601 may be configured to, based on the location information of the user's head, determine a spherical reference plane. The target tangent plane determining module 602 may be configured to determine the plane tangential to the reference point on the spherical reference plane as the target tangent plane. The virtual interface configuring module 603 may be configured to configure the target virtual interface based on the target tangent plane.

The disclosed display device of the virtual interface may determine the spherical reference plane based on the location information of the user's head, then determine a plane that is tangential to the reference point on the spherical reference plane as a target tangent plane, and further configure the target virtual interface based on the target tangent plane. The disclosed display device of the virtual interface may allow all distances between the virtual interfaces displayed in different orientations and the user to be desired display distances. Further, the virtual interfaces may be each displayed in a plane, thereby satisfying focusing and reading habits of human eyes. That is, the user may relatively comfortably watch the virtual interfaces displayed in the space, and the user experience may be relatively good.

In the display device of the virtual interface provided by embodiments of the present disclosure, the spherical reference plane determining module 601 may be specifically configured to use the central point of the user's head or the midpoint of the line connecting two eyes of the user's head as the center of the sphere, and determine the spherical reference plane based on the center of the sphere.

In the display device of the virtual interface provided by embodiments of the present disclosure, the spherical reference plane determining module 601 may include a distance determining sub-module, a radius acquiring sub-module, and a spherical reference plane determining sub-module.

More specifically, the distance determining sub-module may be configured to, based on the location information of the user's head, determine the distance between the user's head and the existing display interface. The radius acquiring sub-module may be configured to, based on the distance determined by the distance determining sub-module, acquire the radius of the spherical reference plane. The spherical reference plane determining sub-module may be configured to, based on the radius acquired by the radius acquiring sub-module, determine the spherical reference plane.

In the display device of the virtual interface provided by embodiments of the present disclosure, the target tangent plane determining module 602 may comprise a reference point determining sub-module and a target tangent plane determining sub-module.

More specifically, the reference point determining sub-module may be configured to, based on the status information of at least one existing display interface, determine a first reference point on the spherical reference plane. The target tangent determining sub-module may be configured to determine the plane tangential to the first reference point as the target tangent plane.

In the display device of the virtual interface provided by embodiments of the present disclosure, the reference point determining sub-module may be specifically configured to, based on the location and dimension of at least one existing display interface adjacent to the to-be-displayed location of the target virtual interface and the dimension of the target virtual interface, determine the first reference point on the spherical reference plane.

In the disclosed display device of the virtual interface, the existing display interface may be a physical display screen or a virtual display screen.

In the disclosed display device of the virtual interface, the virtual interface configuring module 603 may be specifically configured to use the reference point where the target tangent plane is tangential to the spherical reference plane, configure the virtual interface in the target tangent plane.

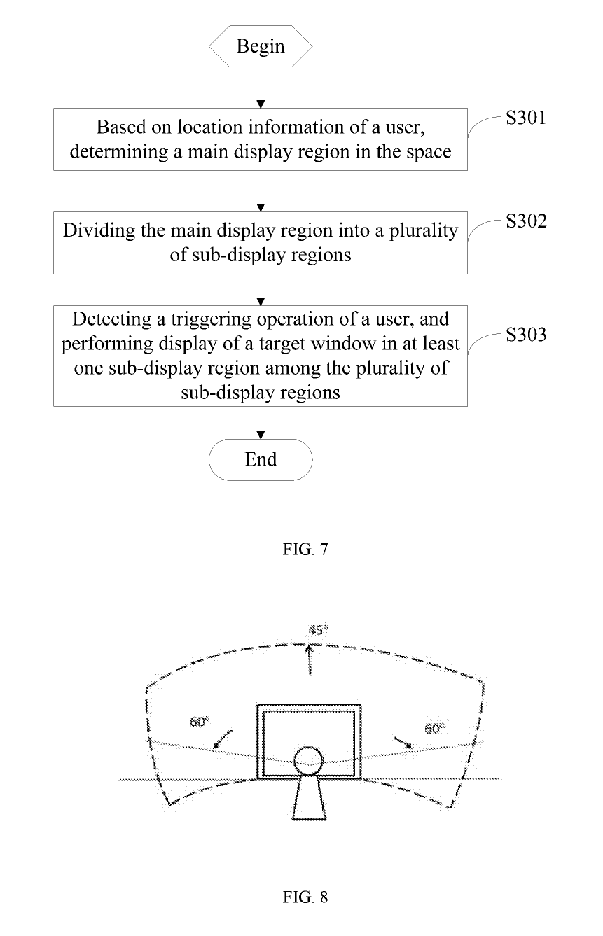

Further, the present disclosure may also be applied to other applications. For example, the present disclosure further provides another display method. FIG. 7 illustrates a flow chart of a display method according to embodiments of the present disclosure. As shown in FIG. 7, the display method may comprise the following steps:

Step S301: based on location information of a user, determining a main display region in the space.

Step S302: dividing the main display region into a plurality of sub-display regions.

Step S103: detecting a triggering operation of the user, and performing display of a target window in at least one sub-display region among the plurality of sub-display regions.

The aforementioned display method provided by embodiments of the present disclosure may, based on the location information of the user, determine the main display region in the space and divide the main display region into a plurality of sub-display regions. When a triggering operation of the user is detected, display of the target window may be performed in at least one sub-display region in the plurality of sub-display regions. In the disclosed display method, by determining the main display region in the space and dividing the main display region, the user may relatively comfortably watch and operate the windows displayed in the space, thereby further enhancing the user experience.

In one embodiment, based on the location information of the user, determining the main display region in the space may further include: acquiring environment information; and based on the location information of the user and the environment information, determining the main display region in the space. For example, FIG. 8 illustrates a schematic view of a main display region according to embodiments of the present disclosure.

As shown in FIG. 8, when an electronic device comprising a display screen is placed on a desktop, the collected environment information may be information of the desktop and information of the display screen in the electronic device. Further, the main display region in the space may be defined by a first preset angle (e.g., 60 degrees) to the left or right using the location of the user as a reference, and may be further defined by a second preset angle (e.g., 45 degrees) upwards and downwards using the plane where the desktop is as a reference. The location of the user may be the midpoint of a line connecting the two eyes of the user or a central point of the user's head. Further, the main display region may be eventually determined by taking into consideration a proper distance (e.g., 45 cm) from the user to the main display region for precise reading and operation, the location where the electronic device is placed, and the height of the electronic device that is placed on the desktop.

Further, for example, a virtual interface may be displayed in the space, and a user may watch the virtual interface in the space. The main display region may be determined based on the location information of the user and the information of virtual interface. The information of virtual interface may include display location of the virtual interface and dimension information of the virtual interface. The main display region may be a display region defined by a first preset angle (e.g., 60 degrees) to the left or right using the location of the user as a reference, and may be further defined by a second preset angle (e.g., 45 degrees) upwards and downwards using a plane perpendicular to the plane where the virtual interface is as a reference. The main display region is eventually determined by taking into consideration a proper distance (e.g., 45 cm) for precise reading and operation, the display location of the virtual interface, and the dimension of the virtual interface.

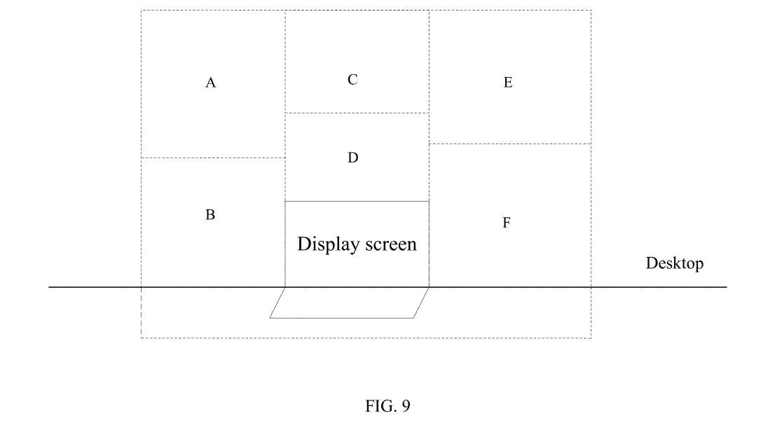

After the main display region is determined, the main display region may be divided into a plurality of sub-display regions. In one embodiment, to allow window(s) shown on the display screen of the electronic device to be relatively well displayed in a sub-display region, the main display region may be divided into a plurality of sub-display regions based on the dimension of the display screen of the electronic device. FIG. 9 illustrates a schematic view of a plurality of sub-display regions divided based on a dimension of a display screen of an electronic device according to embodiments of the present disclosure.

As shown in FIG. 9, the main display region may be divided into a sub-display region A, a sub-display region B, a sub-display region C, a sub-display region D, a sub-display region E, and a sub-display region F. The sub-display region D may have the same dimension as the display screen of the electronic device, and the sub-display regions A, B, C, E and F may have dimensions different from that of the display screen of the electronic device. Further, dimensions of the sub-display regions A, B, C, E, and F may be different from each other.

It can be understood that, when dividing the main display region into a plurality of sub-display regions, the dimension of each sub-display region may not be ensured to be the same as the dimension of the display screen of the electronic device. Accordingly, when division is performed, for the window to have a relatively good display effect, region-dividing rules may be pre-configured based on the shape and dimension of the main display region. Thus, a plurality of the sub-display regions may have the same dimension as the display screen of the electronic device, and a plurality of the sub-display regions may have dimensions greater than the dimension of the display screen of the electronic device.

In one embodiment, for the user to acquire the range of the main display region, the border of the main display region may be displayed using a preset highlighting display method. For example, a certain kind of color may be used to continuously highlight and display the border of the main display region. Or, when the user drags a window, the border of the main display region may be highlighted and displayed in a certain color. Or, when the user drags a window on the display screen of the electronic device for display in the space, the border of the main display region may be highlighted and displayed in a certain color.

For a window to be displayed in the space, the window may be displayed in a first display effect in the main display region. Further, in display regions other than the main display region, the window may be displayed in a second display effect that is different from the first display effect.

For example, when the user executes a certain operation on the window, such as dragging the window into the space or dragging the window to move in the space, etc., if there is only one window in the space, situations where a portion of the window is in the main display region and another portion of the window is outside of the main display region may exist.

To enable the user to more directly acquire the position of the window in the space, portions of the window inside and outside of the main display region may be displayed in different display effects. For example, the portion of window inside the main display region may have a first degree of transparency, and the portion of the window outside of the main display region may have a second degree of transparency. The first degree of transparency may be different from the second degree of transparency. Or, optionally, the window border of the portion of the window inside the main display region may be displayed in one color, and the window border of the portion of the window outside of the main display region is displayed in another color.

If a plurality of windows exist in the space, situations where a plurality of the windows are entirely displayed inside the main display region and a plurality of the windows are entirely displayed outside of the main display region may exist. Further, windows inside the main display region and windows outside of the main display regions may be displayed in different display effects. For example, windows inside the main display region may have a first degree of transparency, and windows outside of the main display region may have a second degree of transparency. The first degree of transparency may be different from the second degree of transparency.

Further, optionally, situations where a plurality of the windows are entirely inside the main display region, a plurality of the windows are entirely outside of the main display region, and a plurality of the windows partially occupy the main display region and partially occupy regions outside of the main display region may exist. Optionally, the windows entirely inside the main display region may have a first degree of transparency, and the windows entirely outside of the main display region may have a second degree of transparency. Further, for windows occupying both the main display region and regions outside of the main display region, the portions of the windows inside the main display region may have a first degree of transparency, and the portions of the windows outside of the main display region may have a second degree of transparency. The first degree of transparency may be different from the second degree of transparency.

To enable the user to acquire the dividing conditions of the sub-display regions in the main display region, the display method provided by embodiments of the present disclosure may further comprise: displaying a border of a sub-display region based on a preset display method.

For example, the border of the sub-display region may be displayed when the main display region is displayed, or may not be displayed until some operations are detected. Optionally, when the dragging operation on the target window is detected, the border of the sub-display region may be displayed in a preset display method (e.g., in thick solid lines of a certain color).

In another optional embodiment, when the dragging operation on the target window is detected, whether the dragging operation satisfies the preset condition is determined. When the dragging operation satisfies the preset condition, the border of the sub-display region may be displayed in the preset display method, where the preset condition may be a dragging operation across windows.

When the target window is displayed in a certain sub-display region in the main display region, to realize a shortcut operation on the window, the disclosed method may perform display of the target window in at least one sub-display region among a plurality of sub-display regions by detecting the triggering operation of the user.

More specifically, based on the detected triggering operation, the target window may be maximally displayed in the sub-display region; and/or, the target window may be displayed in a preset region on a first side of the sub-display region; and/or, the target window may be displayed in the sub-display region by extending to the border of the sub-display region along a preset direction. The triggering operation may include an operation of moving an operating point of the target window to touch the border of the sub-display region.

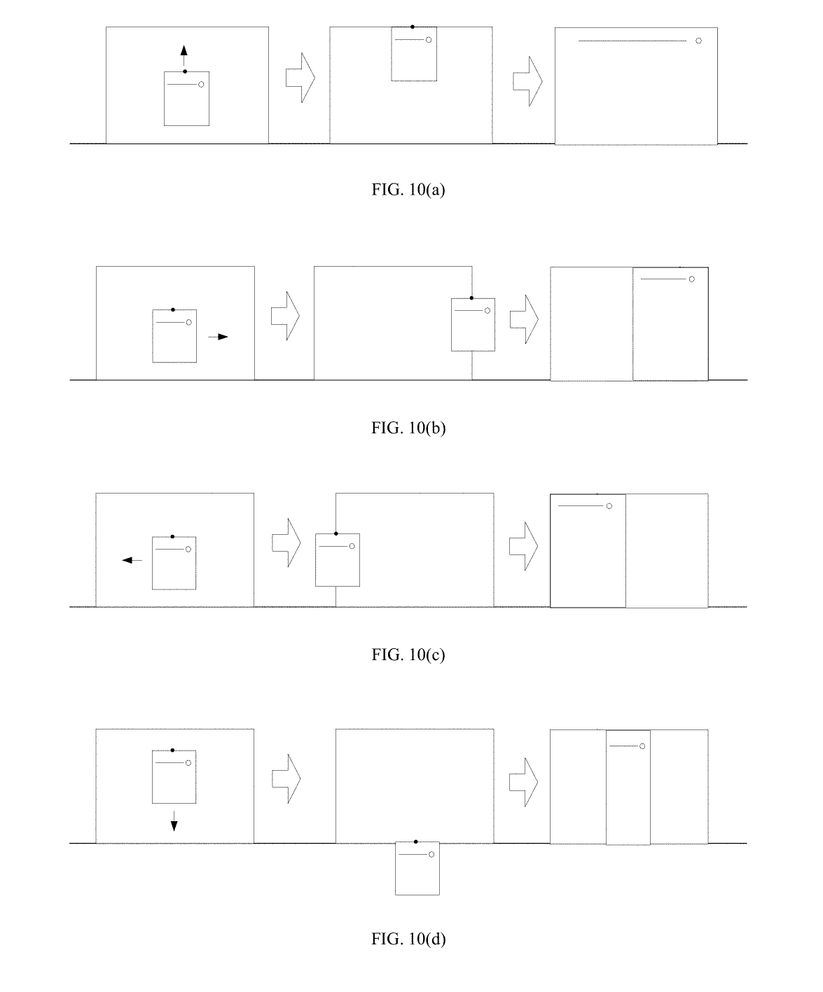

FIG. 10(a)˜FIG. 10(d) illustrate schematic views of displaying a target window in a sub-display region based on a triggering operation of a user according to embodiments of the present disclosure. As shown in FIG. 10(a)˜FIG. 10(d), the process of displaying the target window in the sub-display region based on the triggering operation of the user is illustrated in detail (assuming that the target window is displayed in a sub-display region).

Referring to FIG. 10(a), if the user drags the target window to move towards the top side of the sub-display region, when the operating point of the target window is moved to touch the border of the top side of the sub-display region, the target window may be maximally displayed in the sub-display region.

Referring to FIG. 10(b), if the user drags the target window to move towards the right side of the sub-display region, when the operating point of the target window is moved to touch the right-side border of the sub-display region, the target window is displayed in a preset right-side region of the sub-display region (e.g., the half right-side region of the sub-display region).

Referring to FIG. 10(c), if the user drags the target window to move towards the left side of the sub-display region, when the operating point of the target window is moved to touch the left-side border of the sub-display region, the target window is displayed in the preset left-side region of the sub-display region (e.g., the half left-side region of the sub-display region).

Referring to FIG. 10(d), if the user drags the target window to move towards the bottom of the sub-display region, when the operating point of the target window is moved to touch the bottom border of the sub-display region, the top of the target window is extended to the top side of the sub-display region and the bottom of the target window is extended to the bottom side of the sub-display region for display. That is, the length of the target window may be elongated to be equal to the length of the sub-display region, and the width of the target window may remain unchanged.

In the disclosed display method, the main display region may be divided into a plurality of sub-display regions. Accordingly, when a plurality of windows are displayed in the space, shortcut management of the plurality of windows may be realized based on the plurality of sub-display regions, and the windows disorderly displayed in the space may be arranged rapidly in the divided sub-display regions based on a certain order.

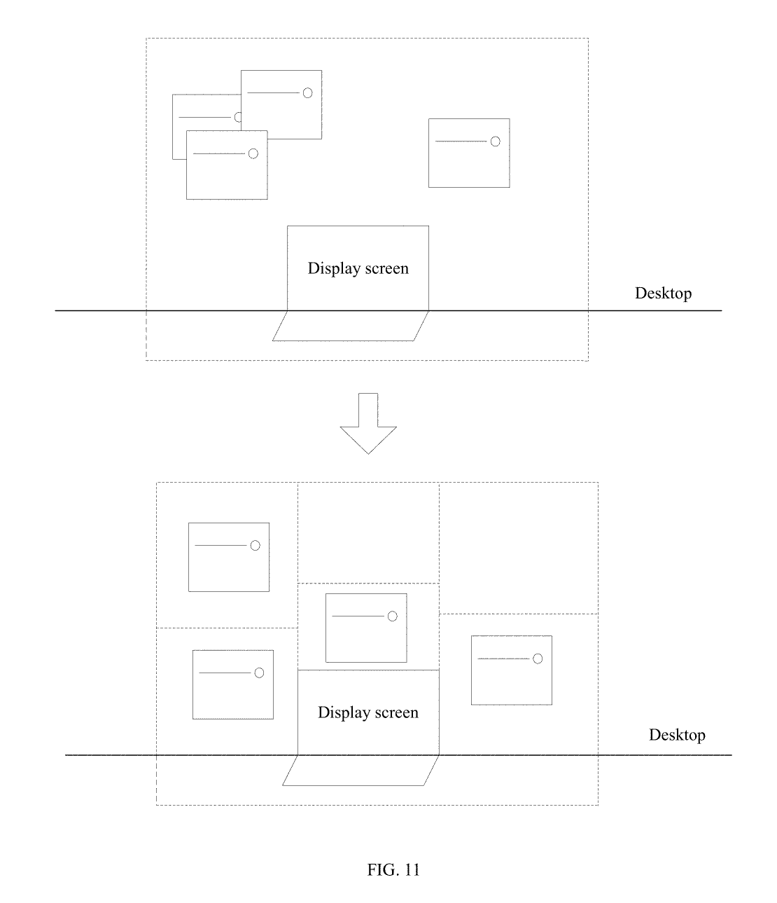

That is, the disclosed display method may further include: based on a preset operation, configuring a plurality of windows shown in the main display region for display in at least one sub-display region, where each window is displayed within the range of a sub-display region. That is, a window displayed in a sub-display region may not exceed the range of the sub-display region. FIG. 11 illustrates a schematic view of displaying a plurality of windows within a main display region in a plurality of sub-display regions within the main display region according to embodiments of the present disclosure. As shown in FIG. 11, in the disclosed display method, the user may realize quick organization of the plurality of windows in the space via a simple shortcut organizing operation.

In an optional embodiment, for each window, the sub-display region of the window may be configured and determined based on the distance from the window to each sub-display region. More specifically, the distances between the center of the window to the center of each sub-display region may be calculated, and the sub-display region closest to the window may be determined as the sub-display region for the window. Optionally, the situation where a plurality of windows are configured in the same sub-display region may exist, and the plurality of windows may be stacked in a certain order within the sub-display region.

Based on the aforementioned display method, detailed descriptions are provided hereinafter for illustrative purposes. In one example, a user may wear AR glasses, and the AR glasses may be connected to a personal computer (PC). The AR glasses may collect the location information of the user wearing the AR glasses, the information of the desktop where the PC is placed, and the information of the PC display screen, and the collected location information of the user, the information of the desktop where the PC is placed and the information of the PC display screen may then be sent to the PC. Optionally, the PC may directly utilize a camera to collect the above-described information.

After acquiring the location information of the user, the information of the desktop where the PC is placed, and the information of the PC display screen, the main display region in the space may be determined based on such information, thereby guiding the user to display a window in the main display region. After determining the main display region, because the window to be displayed in the space is the window displayed on the PC display screen, to allow the window to have a relatively good display effect, the main display region is divided into a plurality of sub-display regions based on a dimension of the PC display screen. Accordingly, the main display region may display a plurality of windows in a certain order to avoid disorder and mess.

Further, the AR glasses may process and display the content of the plurality of windows displayed in the main display region to the user. For the window displayed in the sub-display region, some shortcut operations may be configured to reduce the usage burden of the user. For example, if the user drags a window to move towards the top side of the sub-display region, when the operating point of the target window is moved to touch the top border of the sub-display region, the target window may be maximally displayed in the sub-display region.

Further, to allow the user to acquire the range of the main display region and highlight the border of the main display region, the border of the main display region may be displayed continuously using a certain type of color or may be displayed upon some operations performed by the user on the window. Such operations may include dragging the window to move in the space or dragging the window displayed on the PC display screen into the space. The window displayed in the space may be displayed in different display effects inside and outside of the main display region, thereby differentiating the windows displayed inside and outside of the main display region. For the plurality of windows displayed disorderly in the space, shortcut management may be performed, such that the plurality of windows are displayed in a certain order in at least one sub-display region of the main display region.

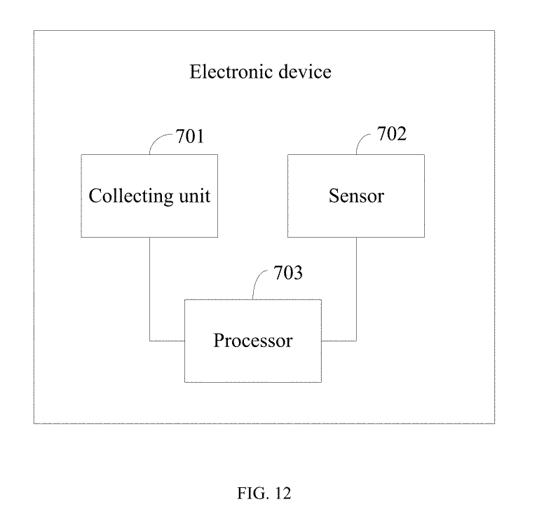

The present disclosure further provides an electronic device. FIG. 12 illustrates a structural schematic view of an electronic device according to embodiments of the present disclosure. As shown in FIG. 12, the electronic device may include a collecting unit 701, a sensor 702, and a processor 703.

The collecting unit 701 may be configured to collect location information of a user. The sensor 702 may be configured to detect a triggering operation of the user. The processor 703 may be configured to, based on the location information of the user collected by the collecting unit 701, determine a main display region in the space and divide the main display region into a plurality of sub-display regions. Further, when the sensor 702 detects the triggering operation of the user, the processor 703 may perform display of a target window in at least one sub-display region among the plurality of sub-display regions.

Optionally, the collecting unit 701 may be a single camera, or multiple cameras, or any device for capturing location information of a physical object. The collecting unit 701 may also be a sensor or may be integrated into the sensor 702. Optionally, the processor 703 may be one or more hardware devices, such as a central processing unit (CPU), a graphics processing unit (GPU), a digital signal processor (DSP), etc., that are able to execute computer-readable instructions stored in a memory.

The aforementioned electronic device provided by embodiments of the present disclosure may, based on the location information of the user, determine the main display region in the space and divide the main display region into a plurality of sub-display regions. When a triggering operation of the user is detected, display of the target window may be performed in at least one sub-display region in the plurality of sub-display regions. Using the display device provided by embodiments of the present disclosure, the main display region in the space may be determined and may be further divided into sub-display regions. Accordingly, the user may relatively comfortably watch and operate the windows displayed in the space, such that the user experience is further enhanced.

In the aforementioned electronic device, the collecting unit 701 may be further configured to collect environment information. The processor 703 may be configured to, based on the location information of the user and the environment information, determine the main display region in the space.

In the aforementioned electronic device, the processor 703 may be specifically configured to, based on the dimension of the display screen in the electronic device, divide the main display region into a plurality of sub-display regions.

In the aforementioned embodiments, the processor 703 may be further configured to, for a window to be displayed in the space, display the window using a first display effect in the main display region, and display the window using a second display effect that is different from the first display effect in display regions other than the main display region.

Optionally, in the aforementioned electronic device, the processor 703 may be further configured to, when the sensor 702 detects a dragging operation on the target window, determine whether the dragging operation satisfies a preset condition. When the dragging operation satisfies the preset condition, the border of the sub-display region may be displayed in a preset display method.

Optionally, in the aforementioned electronic device, the processor 703 may be specifically configured to, based on the detected triggering operation, maximally display the target window in the sub-display region; and/or, display the target window in a preset region on the first side of the sub-display region; and/or, display the target window in the sub-display region by extending to the border of the sub-display region along a preset direction. The triggering operation may include an operation of moving an operating point of the target window to touch the border of the sub-display region.

Optionally, in the aforementioned electronic device, the processor 703 may be further configured to, based on the preset operation, display a plurality of windows displayed within the main display region in at least one sub-display region, where any window is displayed within the range of a sub-display region.

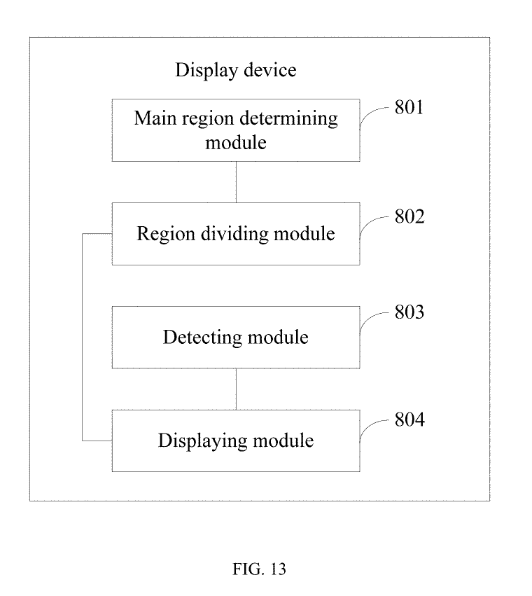

The present disclosure further provides a display device. FIG. 13 illustrates a structural schematic view of a display device according to embodiments of the present disclosure. As shown in FIG. 13, the display device may include a main region determining module 801, a region dividing module 802, a detecting module 803, and a displaying module 804.

More specifically, the main region determining module 801 may be configured to, based on location information of a user, determine a main display region in the space. The region dividing module 802 may be configured to divide the main display region into a plurality of sub-display regions. The detecting module 803 may be configured to detect a triggering operation of the user. The displaying module 804 may be configured to, when the triggering operation of the user is detected, perform display of a target window in at least one sub-display region among the plurality of sub-display regions.

The aforementioned display device provided by embodiments of the present disclosure may, based on the location information of the user, determine the main display region in the space and divide the main display region into a plurality of sub-display regions. When a triggering operation of the user is detected, display of the target window may be performed in at least one sub-display region among the plurality of sub-display regions. In the display device provided by embodiments of the present disclosure, by determining the main display region in the space and dividing the main display region, the user may relatively comfortably watch and operate the windows displayed in the space, thereby further enhancing the user experience.

In the aforementioned display device, the main region determining module 801 may further include an acquiring sub-module and a determining sub-module. The acquiring sub-module may be configured to acquire environment information. The determining sub-module may be configured to, based on the location information of the user and the environment information acquired by the acquiring sub-module, determine the main display region in the space.

In the aforementioned display device, the region dividing module 802 may be specifically configured to, based on the dimension of the display screen in the electronic device, divide the main display region into a plurality of sub-display regions.

The aforementioned display device may further include a window displaying module. The window displaying module may be configured to, for a window to be displayed in the space, display the window in the main display region using a first display effect, and display the window in display regions other than the main display region using a second display effect that is different from the first display effect.

The aforementioned display device may further include a determining module and a sub-display region border-displaying module. The determining module may be configured to, when the dragging operation on the target window is detected, determine whether the dragging operation satisfies a preset condition. The sub-display region border-displaying module may be configured to, when the dragging operation satisfies the preset condition, display the border of the sub-display region in a preset display method.

In the aforementioned display device, the displaying module is specifically configured to, based on the detected triggering operation, maximally display the target window in the sub-display region; and/or, display the target window in a preset region on a first side of the sub-display region; and/or, display the target window in the sub-display region by extending to the border of the sub-display region along a preset direction. The triggering operation may include an operation of moving an operating point of the target window to touch the border of the sub-display region.

The aforementioned display device may further include a window organizing module. The window organizing module may be configured to, based on a preset operation, display a plurality of windows within the main display region in at least one sub-display region, where any window is displayed within the range of a sub-display region.

Various embodiments in the specification are described in a progressive manner, and each embodiment highlights their difference from other embodiments, and the same or similar parts between each embodiment may refer to each other.

In various embodiments of the present disclosure, it should be understood that the disclosed method, device and apparatus may be implemented by other manners. For example, the device described above is merely for illustrative. For example, the units may be merely partitioned by logic function. In practice, other partition manners may also be possible. For example, various units or components may be combined or integrated into another system, or some features may be omitted or left unexecuted. Further, mutual coupling or direct coupling or communication connection displayed or discussed therebetween may be via indirect coupling or communication connection of some communication ports, devices, or units, in electrical, mechanical or other manners.

Units described as separated components may or may not be physically separated, and the components serving as display units may or may not be physical units. That is, the components may be located at one position or may be distributed over various network units. Optionally, some or all of the units may be selected to realize the purpose of solutions of embodiments herein according to practical needs. Further, each functional unit in each embodiment of the present disclosure may be integrated in one processing unit, or each unit may exist physically and individually, or two or more units may be integrated in one unit.

When the described functions are implemented as software function units, and are sold or used as independent products, they may be stored in a computer accessible storage medium. Based on such understanding, the technical solutions of the present disclosure, or the portions contributing to the prior art may be embodied in the form of a software product. The computer software product may be stored in a storage medium, and include several instructions to instruct a computer device (e.g., a personal computer, a server, or a network device) to execute all or some of the method steps of each embodiment. The storage medium described above may include portable storage device, ROM, RAM, a magnetic disc, an optical disc or any other media that may store program codes.

The foregoing is only specific implementation methods of the present disclosure, and the protection scope of the present disclosure is not limited thereto. Without departing from the technical scope of the present disclosure, variations or replacements obtainable by anyone skilled in the relevant art shall all fall within the protection scope of the present disclosure. The protection scope of the subject disclosure is therefore to be limited only by the scope of the appended claims.

What is claimed is:

1. A virtual interface display method, the method comprising:
based on location information of a user's head, determining a spherical reference plane;
determining a plane tangential to a reference point on the spherical reference plane as a target tangent plane;
configuring a target virtual interface based on the target tangent plane; and
displaying the target virtual interface to the user.

2. The method according to claim 1, wherein determining the spherical reference plane includes:
using a central point of the user's head or a midpoint of a line connecting two eyes of the user as a center of the spherical reference plane; and
determining the spherical reference plane based on the center of the spherical reference plane.

3. The method according to claim 1, wherein determining the spherical reference plane includes:
based on the location information of the user's head, determining a distance from the user's head to an existing display interface;
based on the distance, acquiring a radius of the spherical reference plane; and
based on the radius, determining the spherical reference plane.

4. The method according to claim 1, wherein determining the plane tangential to the reference point on the spherical reference plane comprises:
based on status information of at least one existing display interface, determining a first reference point on the spherical reference plane; and
using a plane tangential to the first reference point as the target tangent plane.

5. The method according to claim 4, wherein determining the first reference point on the spherical reference plane comprises:
based on location and dimension information of the at least one existing display interface adjacent to a to-be-displayed location of the target virtual interface and a dimension of the target virtual interface, determining the first reference point on the spherical reference plane.

6. The method according to claim 1, wherein configuring the target virtual interface based on the target tangent plane comprises:
using a reference point where the target tangent plane is tangential to the spherical reference plane as a center, and configuring the virtual interface in the target tangent plane.

7. An electronic device, comprising:
a sensor, wherein the sensor detects location information of a user's head; and
a processor, wherein the processor determines a spherical reference plane based on the location information of the user's head collected by the sensor, determines a plane tangential to a reference point on the spherical reference plane as a target tangent plane, and configures a target virtual interface in the target tangent plane.

8. The electronic device according to claim 7, wherein the processor further:
uses a central point of the user's head or a midpoint of a line connecting two eyes of the user as a center of the spherical reference plane, and
determines the spherical reference plane based on the center of the spherical reference plane.

9. The electronic device according to claim 7, wherein the processor further:
based on the location information of the user's head, determines a distance from the user's head to an existing display interface,
obtains a radius of the spherical reference plane based on the distance, and
determines the spherical reference plane based on the radius.

10. The electronic device according to claim 7, wherein the processor further:
based on status information of at least one existing display interface, determines a first reference point on the spherical reference plane, and
uses a plane tangential to the first reference point as the target tangent plane.

11. The electronic device according to claim 10, wherein the processor further:
based on location and dimension information of the at least one existing display interface adjacent to a location of the target virtual interface and a dimension of the target virtual interface, determines the first reference point on the spherical reference plane.

12. The electronic device according to claim 10, wherein an existing display interface is a physical display screen or a virtual display interface.

13. The electronic device according to claim 8, wherein the processor further:
uses a reference point where the target tangent plane is tangential to the spherical tangent plane as a center, and
configures a virtual interface in the target tangent plane.

14. A virtual display method, comprising:
based on location information of a user, determining a virtual main display region;
dividing the main display region into a plurality of sub-display regions; and
detecting a triggering operation of the user, and performing display of a target window in at least one of the sub-display regions.

15. The display method according to claim 14, wherein dividing the main display region into the plurality of sub-display regions comprises:
based on a dimension of a display screen included in the electronic device, dividing the main display region into the plurality of sub-display regions.

16. The display method according to claim 14, further comprising:
for a window to be displayed in the space, displaying the window in the main display region using a first display effect, and displaying the window in a display region other than the main display region using a second display effect that is different from the first display effect.

17. The display method according to claim 14, further comprising:
in response to detection of a dragging operation on the target window, determining whether the dragging operation satisfies a preset condition; and
in response to the dragging operation satisfying the preset condition, displaying a border of the sub-display region based on a preset display method.

18. The display method according to claim 14, wherein detecting the triggering operation of the user, and performing display of the target window in the at least one sub-display region comprises at least one of:
based on the detected triggering operation, maximally displaying the target window in the sub-display region;
displaying the target window in a preset region on a first side of the sub-display region; and
displaying the target window in the sub-display region by extending to a border of the sub-display region along a preset direction.

19. The display method according to claim 14, wherein:
the triggering operation includes an operation of moving an operating point of the target window to touch a border of the sub-display region.

20. The display method according to claim 14, further comprising:
based on a preset operation, displaying each of the plurality of windows within the respective sub-display regions.
